(19) United States
(12) Patent Application Publication
(10) Pub. No.: US 2022/0289017 A1
(43) Pub. Date: Sep. 15, 2022

(54) MOTOR UNIT, TEMPERATURE CONTROL SYSTEM, AND VEHICLE

(71) Applicant: NIDEC CORPORATION, Kyoto (JP)

(72) Inventors: Hiroaki BESSHO, Kyoto (JP); Ryohei UCHINO, Kyoto (JP)

(21) Appl. No.: 17/631,890

(22) PCT Filed: Jul. 31, 2020
(86) PCT No.: PCT/JP2020/029493

§ 371 Date: Feb. 1, 2022

(30) Foreign Application Priority Data
Aug. 6, 2019 (JP) 2019-144341

(51) Int. Cl. B60K 11/04; B60H 1/03; B60H 1/06; B60H 1/22; B60L 3/00

(52) U.S. Cl. CPC B60K 11/04; B60H 1/03; B60H 1/06; B60H 1/22; B60L 3/003

(57) ABSTRACT

One aspect of a motor unit of the present invention is a motor unit that is mounted on a vehicle, and includes a motor that drives the vehicle, an inverter electrically connected to the motor, a temperature control heat exchanger connected to a temperature control device of the vehicle, and a refrigerant circuit that is a path through which a refrigerant circulates. The refrigerant circuit includes a first circulation path and a second circulation path that are switched to each other. The first circulation path is a path passing through the inverter and the temperature control heat exchanger. The second circulation path is a path passing through the inverter, the temperature control heat exchanger, and the motor.

### CROSS-REFERENCE TO RELATED APPLICATIONS

This is the U.S. national stage of application No. PCT/JP2020/029493, filed on Jul. 31, 2020, and priority under 35 U.S.C. § 119(a) and 35 U.S.C. § 365(b) is claimed from Japanese Patent Application No. 2019-144341, filed on Aug. 6, 2019.

### FIELD OF THE INVENTION

The present invention relates to a motor unit, a temperature control system, and a vehicle.

### BACKGROUND

An electric vehicle or a hybrid electric vehicle is required to be equipped with a refrigerant circuit that cools a motor and an inverter. It is known that heat of cooling water used for cooling an inverter and a motor is used for an in-vehicle temperature control device.

In a cold district and the like, a motor of a motor unit maintains a low temperature for a certain period of time from the start. In contrast, an inverter rapidly generates heat. A refrigerant that passes through the inverter and the motor is heated by the heat of the inverter and cooled by the motor. For this reason, there has been a problem that heat cannot be sufficiently taken out by a heat exchanger in a case where heat of the refrigerant is used in a temperature control device.

### SUMMARY

One aspect of a motor unit of the present invention is a motor unit that is mounted on a vehicle, and includes a motor that drives the vehicle, an inverter electrically connected to the motor, a temperature control heat exchanger connected to a temperature control device of the vehicle, and a refrigerant circuit that is a path through which a refrigerant circulates. The refrigerant circuit includes a first circulation path and a second circulation path that are switched to each other. The first circulation path is a path passing through the inverter and the temperature control heat exchanger. The second circulation path is a path passing through the inverter, the temperature control heat exchanger, and the motor.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a conceptual diagram of a vehicle according to an embodiment;

FIG. 2 is a flowchart illustrating steps executed by a control unit according to the embodiment; and

FIG. 3 is a conceptual diagram of a motor unit of a third variation.

### DETAILED DESCRIPTION

Hereinafter, a vehicle, a motor unit, and a temperature control system according to an embodiment of the present invention will be described with reference to the drawings. Note that scales, numbers, and the like of structures illustrated in the drawings below may differ from those of an actual structure, for the sake of easier understanding of configurations.

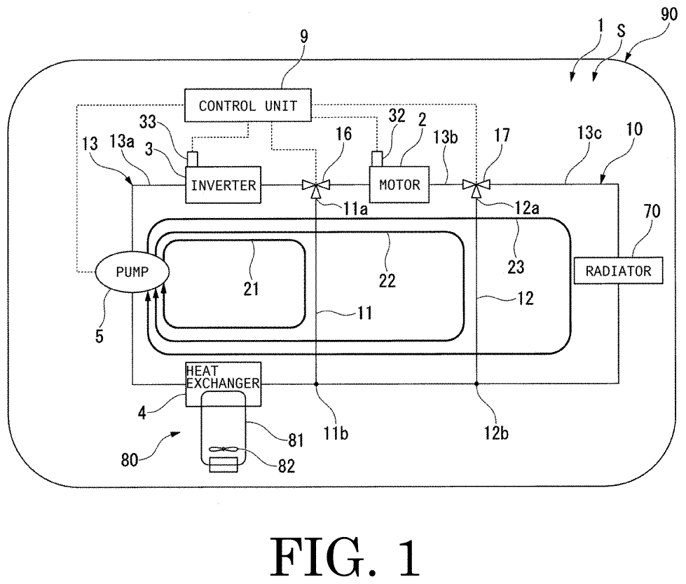

FIG. 1 is a conceptual diagram of a vehicle 90 according to an embodiment.

The vehicle 90 includes a motor unit 1, a temperature control device 80, and a radiator 70. The motor unit 1, the temperature control device 80, and the radiator 70 constitute a temperature control system S. That is, the vehicle 90 includes the temperature control system S. The motor unit 1 includes a refrigerant circuit 10 that is a path through which a refrigerant circulates. The radiator 70 cools a refrigerant in the refrigerant circuit 10. Note that the radiator 70 can also be regarded as constituting a part of the refrigerant circuit 10. In this case, the refrigerant circuit 10 includes the radiator 70.

The temperature control device 80 adjusts a temperature of a living space of the vehicle 90. The temperature control device 80 is connected to the refrigerant circuit 10, receives heat from a refrigerant in the refrigerant circuit 10, and uses the heat to adjust an air temperature of the living space of the vehicle 90. The temperature control device 80 includes a temperature control refrigerant circuit 81 that is a path through which a temperature control refrigerant circulates, and a fan 82 that takes out heat from a temperature control refrigerant circulating through the temperature control refrigerant circuit 81 and blows the heat into the living space of the vehicle 90.

The motor unit 1 is mounted on a vehicle. The motor unit 1 is mounted on a vehicle such as an electric vehicle (EV), a hybrid vehicle (HEV), and a plug-in hybrid vehicle (PHV) in which a motor is used as a power source.

As illustrated in FIG. 1, the motor unit 1 includes a motor 2, an inverter 3, a temperature control heat exchanger 4, a pump 5, the refrigerant circuit 10, and a control unit 9. Further, although not illustrated, the motor unit 1 includes a transmission mechanism (transaxle) that transmits power of the motor 2 to an axle of a vehicle.

The motor 2 is an electric generator having both a function as an electric motor and a function as a generator. The motor 2 mainly functions as an electric motor to drive a vehicle, and functions as a generator during regeneration.

The motor 2 is provided with a motor thermometer 32. The motor thermometer 32 measures a temperature of the motor 2. The motor thermometer 32 is attached to, for example, a coil end of the motor 2. In the present description, a measurement result of a temperature of the motor output from the motor thermometer 32 will be described as a motor temperature Tm.

Note that a location where the motor thermometer 32 is attached is not limited to the coil end. The motor thermometer 32 may be attached to, for example, another representative point of the motor such as a housing that houses the motor. Furthermore, in a case where oil that cools and lubricates each part of the motor is stored in the housing of the motor, the thermometer 32 may measure a temperature of the oil.

The inverter 3 is electrically connected to the motor 2 via a bus bar (not illustrated). The inverter 3 converts a direct current supplied from a battery (not illustrated) into an alternating current and supplies the alternating current to the motor 2 via the bus bar.

The inverter 3 is provided with an inverter thermometer 33. The inverter thermometer 33 measures a temperature of the inverter 3. The inverter thermometer 33 is attached to, for example, a chip or a heat radiator provided in the inverter 3. Further, the inverter thermometer 33 may measure a temperature of a refrigerant passing through the inverter 3. In this case, the inverter thermometer 33 measures temperatures of an inflow portion and an outflow portion of a refrigerant to the inverter 3, and estimates a temperature of the inverter 3 from measured values of these. In the present description, a measurement result of a temperature of the inverter output from the inverter thermometer 33 will be described as an inverter temperature Ti.

The temperature control heat exchanger 4 is connected to the temperature control device 80 of the vehicle 90. The temperature control heat exchanger 4 is arranged in a path of the temperature control refrigerant circuit 81. The temperature control heat exchanger 4 exchanges heat between a refrigerant in the refrigerant circuit 10 and a temperature control refrigerant in the temperature control refrigerant circuit 81. That is, the temperature control heat exchanger 4 transfers heat from a refrigerant in the refrigerant circuit 10 to a temperature control refrigerant in the temperature control refrigerant circuit 81.

The motor 2, the inverter 3, the temperature control heat exchanger 4, the pump 5, and the radiator 70 are connected to the refrigerant circuit 10. The pump 5 pressure-feeds a refrigerant in the refrigerant circuit 10.

The refrigerant circuit 10 includes an annular path 13, a first short-circuit path 11, a second short-circuit path 12, a first three-way valve 16, and a second three-way valve 17. The first three-way valve 16 and the second three-way valve 17 are connected to the control unit 9 and controlled by the control unit 9. That is, the refrigerant circuit 10 is controlled by the control unit 9.

The annular path 13 is a flow path of a refrigerant extending annularly. In the annular path 13, the motor 2, the inverter 3, the temperature control heat exchanger 4, the pump 5, and the radiator 70 are arranged. The annular path 13 is partitioned into a first region 13a, a second region 13b, and a third region 13c. The first region 13a, the second region 13b, and the third region 13c are arranged in this order along a flow direction of a refrigerant in the annular path 13.

In the first region 13a, the inverter 3, the temperature control heat exchanger 4, and the pump 5 are arranged. The motor 2 is arranged in the second region 13b. The radiator 70 is arranged in the third region 13c.

The first short-circuit path 11 is a flow path of a refrigerant extending so as to shortcut a part of the annular path 13. The first short-circuit path 11 has a first end portion 11a located on the upstream side in a flow direction of a refrigerant and a second end portion 11b located on the downstream side. The first end portion 11a of the first short-circuit path 11 is connected to a boundary portion between the first region 13a and the second region 13b of the annular path 13. On the other hand, the second end portion 11b of the first short-circuit path 11 is connected to a boundary portion between the first region 13a and the third region 13c of the annular path 13. That is, both end portions of the first short-circuit path 11 are connected to both end portions of the first region 13a. The first three-way valve 16 is provided in a connection portion between the first end portion 11a of the first short-circuit path 11 and the annular path 13.

Similarly to the first short-circuit path 11, the second short-circuit path 12 is a flow path of a refrigerant extending so as to shortcut a part of the annular path 13. The second short-circuit path 12 has a first end portion 12a located on the upstream side in a flow direction of a refrigerant and a second end portion 12b located on the downstream side. The first end portion 12a of the second short-circuit path 12 is connected to a boundary portion between the second region 13b and the third region 13c of the annular path 13. On the other hand, the second end portion 12b of the second short-circuit path 12 is connected to a boundary portion between the first region 13a and the third region 13c of the annular path 13. That is, both end portions of the second short-circuit path 12 are connected to both end portions of the third region 13c. The second three-way valve 17 is provided in a connection portion between the first end portion 12a of the second short-circuit path 12 and the annular path 13.

The first three-way valve 16 and the second three-way valve 17 are provided to switch a flow path through which a refrigerant passes in the refrigerant circuit 10. In the present description, a state in which the first three-way valve 16 and the second three-way valve 17 close a part of the annular path 13 and guide a refrigerant from the annular path 13 to the short-circuit path (the first short-circuit path 11 or the second short-circuit path 12) is referred to as a short-circuit state, and a state in which the short-circuit path is closed and a refrigerant is guided along the annular path 13 is referred to as a steady state.

The first three-way valve 16 is arranged in a connection portion between the annular path 13 and the first short-circuit path 11. The first three-way valve 16 is switched between the short-circuit state and the steady state by the control unit 9. The short-circuit state of the first three-way valve 16 is a state in which the first region 13a of the annular path 13 communicates with the first short-circuit path 11 and an end portion on the upstream side of the second region 13b is closed. The steady state of the first three-way valve 16 is a state in which the first region 13a and the second region 13b of the annular path 13 communicate with each other and the first end portion 11a of the first short-circuit path 11 is closed.

The second three-way valve 17 is arranged in a connection portion between the annular path 13 and the second short-circuit path 12. The second three-way valve 17 is switched between the short-circuit state and the steady state by the control unit 9. The short-circuit state of the second three-way valve 17 is a state in which the second region 13b of the annular path 13 communicates with the second short-circuit path 12 and an end portion on the upstream side of the third region 13c is closed. The steady state of the second three-way valve 17 is a state in which the second region 13b and the third region 13c of the annular path 13 communicate with each other and the first end portion 12a of the second short-circuit path 12 is closed.

The refrigerant circuit 10 is switched to a first circulation path 21, a second circulation path 22, and a third circulation path 23 by operation of the first three-way valve 16 and the second three-way valve 17 by the control unit 9. That is, the refrigerant circuit 10 includes the first circulation path 21, the second circulation path 22, and the third circulation path 23 which are alternatively switched. Further, the control unit 9 alternatively switches the first circulation path 21, the second circulation path 22, and the third circulation path 23 in the refrigerant circuit 10.

Note that, in the present embodiment, the first circulation path 21, the second circulation path 22, and the third circulation path 23 are switched by control of the first three-way valve 16 and the second three-way valve 17 by the control unit 9. However, the present invention is not limited to this configuration. For example, the first circulation path 21, the second circulation path 22, and the third circulation path 23 may be configured to be automatically switched using a thermostat as a temperature of each part rises. That is, the refrigerant circuit 10 is only required to alternatively select any one of the first circulation path 21, the second circulation path 22, and the third circulation path 23 to circulate a refrigerant.

The first circulation path 21 is an annular path including the first region 13a of the annular path 13 and the first short-circuit path 11. The first circulation path 21 is configured by setting the first three-way valve 16 in the short-circuit state. The first circulation path 21 is a path passing through the pump 5, the inverter 3, and the temperature control heat exchanger 4.

In the first circulation path 21, a refrigerant cools the inverter 3 and is heated by heat of the inverter 3 when passing through the inverter 3. Further, a refrigerant is cooled by the temperature control refrigerant circuit 81 when passing through the temperature control heat exchanger 4. That is, in the first circulation path 21, a refrigerant transfers heat from the inverter 3 to the temperature control heat exchanger 4.

The second circulation path 22 is an annular path including the first region 13a and the second region 13b of the annular path 13 and the second short-circuit path 12. The second circulation path 22 is configured by setting the first three-way valve 16 to the steady state and setting the second three-way valve 17 to the short-circuit state. The second circulation path 22 is a path passing through the pump 5, the inverter 3, the temperature control heat exchanger 4, and the motor 2.

In the second circulation path 22, a refrigerant cools the inverter 3 and the motor 2 and is heated by the inverter 3 and the motor 2 when passing through the inverter 3 and the motor 2. Further, a refrigerant is cooled by the temperature control refrigerant circuit 81 when passing through the temperature control heat exchanger 4. That is, in the second circulation path 22, a refrigerant transfers heat from the inverter 3 and the motor 2 to the temperature control heat exchanger 4.

The third circulation path 23 is an annular path including the entire annular path 13 (that is, the first region 13a, the second region 13b, and the third region 13c). The third circulation path 23 is configured by setting the first three-way valve 16 and the second three-way valve 17 to the steady state. The second circulation path 22 is a path passing through the pump 5, the inverter 3, the temperature control heat exchanger 4, the motor 2, and the radiator 70.

In the third circulation path 23, a refrigerant cools the inverter 3 and the motor 2 and is heated by heat of the inverter 3 and the motor 2 when passing through the inverter 3 and the motor 2. Further, a refrigerant is cooled by the temperature control refrigerant circuit 81 and the radiator 70 when passing through the temperature control heat exchanger 4 and the radiator 70. That is, in the third circulation path 23, a refrigerant transfers heat from the inverter 3 and the motor 2 to the temperature control heat exchanger 4 and the radiator 70.

The pump 5, the motor thermometer 32, the inverter thermometer 33, the first three-way valve 16, and the second three-way valve 17 are connected to the control unit 9. The control unit 9 operates the first three-way valve 16 and the second three-way valve 17 based on the motor temperature Tm measured by the motor thermometer 32 and the inverter temperature Ti measured by the inverter thermometer 33. Further, the control unit 9 also operates the first three-way valve 16 and the second three-way valve 17 to switch the first circulation path 21, the second circulation path 22, and the third circulation path 23.

Note that the control unit 9 may be a part of a control device (for example, ECU: Electronic Control Unit) of a vehicle.

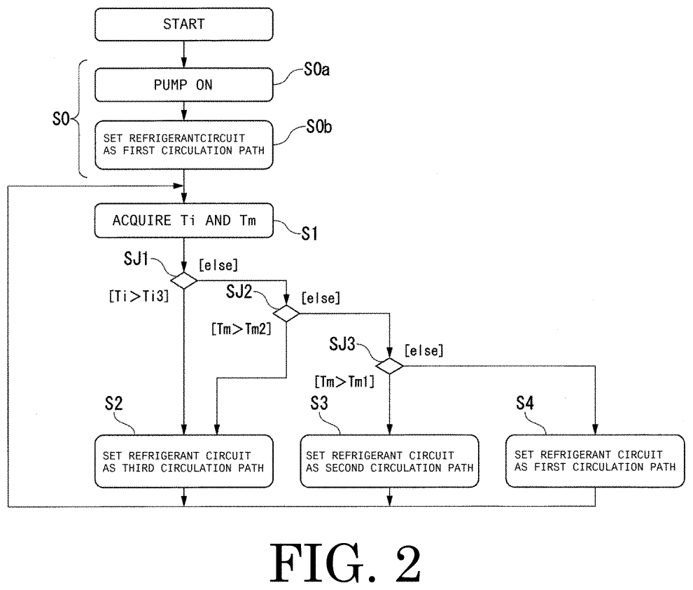

FIG. 2 is a flowchart illustrating steps executed by the control unit 9.

The control unit 9 executes a preliminary step S0, a first execution step S1, a second execution step S2, a third execution step S3, a fourth execution step S4, a first determination step SJ1, a second determination step SJ2, and a third determination step SJ3.

In the preliminary step S0, the control unit 9 includes a first preliminary step S0a and a second preliminary step S0b. In the first preliminary step S0a, the control unit 9 drives the pump 5. For example, the control unit 9 executes the first preliminary step S0a in response to turning on of an ignition switch of a vehicle. Further, in the second preliminary step S0b, the control unit 9 sets the refrigerant circuit 10 as the first circulation path 21. That is, in the second preliminary step S0b, the control unit 9 sets the first three-way valve 16 to the short-circuit state. Note that, in the second preliminary step S0b, the second three-way valve 17 may be in the short-circuit state or the steady state.

In FIG. 2, the order of the first preliminary step S0a and the second preliminary step S0b may be reversed. Further, the first preliminary step S0a and the second preliminary step S0b may be executed simultaneously.

In the first execution step S1, the control unit 9 acquires the motor temperature Tm from the motor thermometer 32 and acquires the inverter temperature Ti from the inverter thermometer 33.

In the first determination step SJ1, the control unit 9 compares the inverter temperature Ti with a third threshold Ti3. The third threshold Ti3 is, for example, a threshold of a temperature of the inverter 3 set in advance in the control unit 9. In this case, as the third threshold Ti3, for example, a temperature obtained by adding a sufficient safety factor to a temperature at which damage to the inverter 3 is concerned is set. Note that the third threshold Ti3 may be a variable calculated from an outside air temperature and a request to the temperature control device.

In the first determination step SJ1, in a case where the inverter temperature Ti is higher than the third threshold Ti3 (Ti>Ti3), the control unit 9 proceeds to the second execution step S2 and executes the second execution step S2.

In the first determination step SJ1, in a case where the inverter temperature Ti is equal to or lower than the third threshold Ti3 (Ti≤Ti3), the control unit 9 performs the second determination step SJ2.

In the second determination step SJ2, the control unit 9 compares the motor temperature Tm with a second threshold Tm2. The second threshold Tm2 is a threshold of a temperature of the motor 2 set in advance in the control unit 9. As the second threshold Tm2, for example, a temperature obtained by adding a sufficient safety factor to a temperature at which damage to the motor 2 is concerned is set. A value larger than a first threshold Tm1 to be described later is set as the second threshold Tm2.

In the second determination step SJ2, in a case where the motor temperature Tm is higher than the second threshold Tm2 (Tm>Tm2), the control unit 9 proceeds to the second execution step S2 and executes the second execution step S2.

In the second determination step SJ2, in a case where the motor temperature Tm is equal to or lower than the second threshold Tm2 (Tm≤Tm2), the control unit 9 proceeds to the third determination step SJ3.

In the second execution step S2, the control unit 9 sets the refrigerant circuit 10 as the third circulation path. That is, in the second execution step S2, the control unit 9 sets both the first three-way valve 16 and the second three-way valve 17 to the steady state. After executing the second execution step S2, the control unit 9 proceeds to the first execution step S1 again.

The second execution step S2 is executed in a case where the inverter temperature Ti is higher than the third threshold Ti3 or the motor temperature Tm is higher than the second threshold Tm2. That is, the control unit 9 sets the refrigerant circuit 10 as the third circulation path 23 in a case where the motor temperature Tm exceeds the second threshold Tm2 or the inverter temperature Ti exceeds the third threshold Ti3.

In the third determination step SJ3, the control unit compares the motor temperature Tm with the first threshold Tm1. The first threshold Tm1 is a threshold of a temperature of the motor 2 set in advance in the control unit 9. For example, an assumed value of a temperature of a refrigerant that has cooled the inverter 3 is set as the first threshold Tm1. A value smaller than the second threshold Tm2 is set as the first threshold Tm1.

In the third determination step SJ3, in a case where the motor temperature Tm is higher than the first threshold Tm1 (Tm>Tm1), the control unit 9 proceeds to the third execution step S3 and executes the third execution step S3.

In the third determination step SJ3, in a case where the motor temperature Tm is equal to or lower than the first threshold Tm1 (Tm≤Tm1), the control unit 9 proceeds to the fourth execution step S4 and executes the fourth execution step S4.

In the third execution step S3, the control unit 9 sets the refrigerant circuit 10 as the second circulation path 22. That is, in the third execution step S3, the control unit 9 sets the first three-way valve 16 to the steady state and sets the second three-way valve 17 to the short-circuit state. After executing the third execution step S3, the control unit 9 proceeds to the first execution step S1 again.

The third execution step S3 is executed in a case where the motor temperature Tm is higher than the first threshold Tm1 and equal to or less than the second threshold Tm2. That is, the control unit 9 sets the refrigerant circuit 10 as the second circulation path 22 in a case where the motor temperature Tm exceeds the first threshold Tm1 and is equal to or less than the second threshold Tm2.

In the fourth execution step S4, the control unit 9 sets the refrigerant circuit 10 as the first circulation path 21. That is, in the fourth execution step S4, the control unit 9 sets the first three-way valve 16 to the short-circuit state. Further, in the fourth execution step S4, the second three-way valve 17 may be in the short-circuit state or the steady state. After executing the fourth execution step S4, the control unit 9 proceeds to the first execution step S1 again.

The fourth execution step S4 is executed in a case where the motor temperature Tm is equal to or less than the first threshold Tm1. That is, the control unit 9 sets the refrigerant circuit 10 as the first circulation path 21 in a case where the motor temperature Tm is equal to or less than the first threshold Tm1.

According to the present embodiment, the motor unit 1 includes the refrigerant circuit 10 and the temperature control heat exchanger 4 arranged in a path of the refrigerant circuit 10 and in a path of the temperature control refrigerant circuit 81. The temperature control heat exchanger 4 exchanges heat between a refrigerant in the refrigerant circuit 10 and a refrigerant in the temperature control refrigerant circuit 81. Therefore, heat taken by the refrigerant circuit 10 cooling the inverter 3 and the motor 2 can be used for temperature adjustment of a living space of the vehicle 90 by the temperature control device 80. That is, according to the present embodiment, it is possible to provide the motor unit 1 having high energy efficiency and the vehicle 90 including the motor unit 1.

In the motor unit 1, since the inverter 3 has a relatively small heat capacity, the temperature rapidly increases due to heat generation after the start. In contrast, since the heat capacity of the motor 2 is relatively large, the temperature rise after the start is gentle. Therefore, the inverter 3 needs to be cooled by the refrigerant circuit 10 immediately after the start. However, the necessity of cooling the motor 2 is low until the temperature sufficiently increases after the start.

Further, in an environment where an outside air temperature is sufficiently low, the motor 2 is cooled by the outside air when a vehicle is stopped. For this reason, immediately after the start, the motor temperature Tm may be lower than a temperature of a refrigerant that has cooled the inverter 3. In a case where the motor temperature Tm is lower than the temperature of the refrigerant, heat of the refrigerant is transferred to the motor 2. That is, the refrigerant is cooled by the motor 2. Since heat of a refrigerant in the refrigerant circuit 10 is used for temperature adjustment of a living space of the vehicle 90 by the temperature control device 80, the heat is exchanged with a temperature control refrigerant in the temperature control refrigerant circuit 81 in the temperature control heat exchanger 4. Since heat exchange efficiency is improved more as a temperature difference is larger, heat exchange efficiency in the temperature control heat exchanger 4 becomes poorer when the refrigerant in the refrigerant circuit 10 is cooled by the motor 2.

According to the present embodiment, the control unit 9 sets the refrigerant circuit 10 as the first circulation path 21 in a case where the motor temperature Tm is equal to or less than the first threshold Tm1. Therefore, according to the present embodiment, in a case where the motor temperature Tm is sufficiently low (Tm≤Tm1), a refrigerant is not supplied to the motor 2, and cooling of the refrigerant by the motor 2 can be suppressed. In this manner, it is possible to improve heat exchange efficiency in the temperature control heat exchanger 4 by maintaining a temperature of the refrigerant.

According to the present embodiment, the control unit 9 sets the refrigerant circuit 10 as the first circulation path 21 in when the motor temperature Tm exceeds the first threshold Tm1 and is equal to or less than the second threshold Tm2. That is, the control unit 9 switches the refrigerant circuit 10 to the second circulation path 22 in a case where the motor temperature Tm exceeds the first threshold Tm1. For this reason, a refrigerant can be supplied to the motor 2 to transfer heat from the motor 2 to the refrigerant at a stage where the motor temperature Tm increases and is considered to be higher than a refrigerant temperature. As a result, it is possible to sufficiently cool the motor 2 to improve driving efficiency, and increase the temperature of the refrigerant to improve heat exchange efficiency in the temperature control heat exchanger 4.

The radiator 70 is connected to the refrigerant circuit 10. The radiator 70 cools a refrigerant in the refrigerant circuit 10. As described above, heat exchange efficiency by the temperature control heat exchanger 4 is improved more as a temperature difference between a refrigerant in the refrigerant circuit 10 and a temperature control refrigerant in the temperature control refrigerant circuit 81 is larger. Therefore, cooling of a refrigerant by the radiator 70 is a factor of deterioration in heat exchange efficiency in the temperature control heat exchanger 4.

According to the present embodiment, the control unit 9 causes a refrigerant to flow through the first circulation path 21 or the second circulation path 22 and not to be supplied to the radiator 70 in a case where the inverter temperature Ti is equal to or less than the third threshold Ti3 and the motor temperature Tm is equal to or less than the second threshold Tm2. That is, the radiator 70 does not cool a refrigerant until the inverter 3 and the motor 2 exceed the preset threshold. As a result, a temperature of the refrigerant can be increased and heat exchange efficiency in the temperature control heat exchanger 4 can be improved.

According to the present embodiment, in a case where the inverter temperature Ti exceeds the third threshold Ti3 or the motor temperature Tm exceeds the second threshold Tm2, the control unit 9 supplies a refrigerant to the radiator 70 by setting the refrigerant circuit 10 as the third circulation path 23. By cooling a refrigerant in the refrigerant circuit 10 by the radiator 70, it is possible to suppress excessive increase in a temperature of the inverter 3 and the motor 2 and to improve driving efficiency of the inverter 3 and the motor 2.

In the present embodiment, the first circulation path 21, the second circulation path 22, and the third circulation path 23 all pass through the first region 13a to circulate a refrigerant. That is, the first circulation path 21, the second circulation path 22, and the third circulation path 23 have a shared path which is the first region 13a. As described above, since the inverter 3 has a relatively low heat capacity, a temperature rise and a temperature fall are generated sensitive to heat generation. According to the present embodiment, the inverter 3 is arranged in the first region 13a included in the first circulation path 21, the second circulation path 22, and the third circulation path 23. That is, in the refrigerant circuit 10, the inverter 3 is arranged on a path (the first region 13a) shared by the first circulation path 21, the second circulation path 22, and the third circulation path 23. Therefore, regardless of which circulation path the control unit 9 selects, the refrigerant always passes through and cools the inverter 3. As a result, even in a case where the inverter temperature Ti suddenly rises, the inverter 3 can be reliably cooled.

According to the present embodiment, the pump 5 is arranged in the first region 13a included in the first circulation path 21, the second circulation path 22, and the third circulation path 23. That is, in the refrigerant circuit 10, the pump 5 is arranged on a path (the first region 13a) shared by the first circulation path 21, the second circulation path 22, and the third circulation path 23. Therefore, regardless of which circulation path the control unit 9 selects, the refrigerant can be circulated by one pump 5.

Next, as a first variation, a case where control different from that of the above-described embodiment is performed by the control unit 9 will be described. In the above-described embodiment, the control unit 9 compares the motor temperature Tm with the first threshold Tm1 and the second threshold Tm2, and compares the inverter temperature Ti with the third threshold Ti3. In contrast, in the present variation, the control unit 9 directly compares the motor temperature Tm with the inverter temperature Ti. Note that, in the present variation, the inverter temperature Ti is obtained by measuring a temperature of a refrigerant after passing through the inverter 3.

In the present variation, the control unit 9 switches the refrigerant circuit 10 from the first circulation path 21 to the second circulation path 22 in a case where the motor temperature Tm becomes higher than the inverter temperature Ti. According to this configuration, in a case where a refrigerant circulates in the second circulation path 22, since the motor temperature Tm is higher than the inverter temperature Ti, the refrigerant that has taken heat from the inverter 3 is not cooled by the motor 2, and heat of the refrigerant can be efficiently used for the temperature control device 80.

Next, as a second variation, another control method of the control unit 9 will be described. In the present variation, the control unit 9 controls the refrigerant circuit 80 based on a temperature of a refrigerant that has passed through the temperature control heat exchanger 4. Here, the temperature of the refrigerant that has passed through the temperature control heat exchanger 4 is defined as a heat exchanger temperature Th.

In the present variation, in a case where the heat exchanger temperature Th exceeds a fourth threshold Th4 (Th>Th4), the control unit 9 sets the refrigerant circuit 10 as the third circulation path 23. According to this configuration, it is possible to suppress the temperature of the refrigerant, which has passed through the temperature control heat exchanger 4, exceeding the preset fourth threshold Th4. As a result, it is possible to suppress excessive increase in a temperature of the inverter 3 and the motor 2 and to improve driving efficiency of the inverter 3 and the motor 2.

Further, when the temperature of the refrigerant after passing through the inverter is the inverter temperature Ti, the refrigerant circuit 10 may be set as the third circulation path in a case of Th≥Ti. Furthermore, in a case where a difference (Ti−Th) between Th and Ti exceeds a predetermined temperature (for example, a fifth threshold T5) (Ti−Th>T5), the refrigerant circuit 10 may be set as the third circulation path.

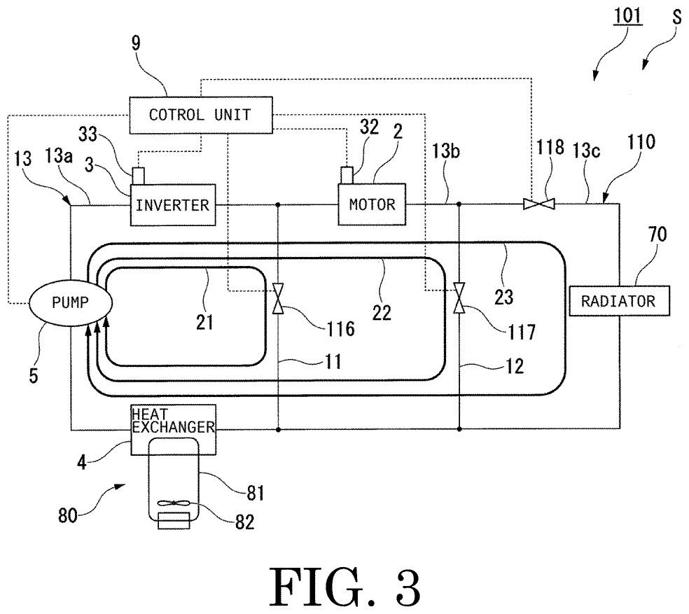

FIG. 3 is a conceptual diagram of a motor unit 101 of a third variation. The motor unit 101 of the present variation is different from the above-described embodiment mainly in that a first valve 116, a second valve 117, and a third valve 118 are provided instead of the first three-way valve 16 and the second three-way valve 17. Note that a constituent element of the identical aspect to that of the above-described embodiment is denoted by the same reference numeral, and omitted from description.

Similarly to the above-described embodiment, the motor unit 101 of the present variation includes the motor 2, the inverter 3, the temperature control heat exchanger 4, the pump 5, a refrigerant circuit 110, and the control unit 9. Further, the motor 2, the inverter 3, the temperature control heat exchanger 4, the pump 5, and the radiator 70 are connected to the refrigerant circuit 110.

The refrigerant circuit 110 of the present variation includes the annular path 13, the first short-circuit path 11, the second short-circuit path 12, the first valve 116, the second valve 117, and the third valve 118. The first valve 116 is arranged in the first short-circuit path 11. Further, the second valve 117 is arranged in the second short-circuit path 12. The third valve 118 is arranged in the third region 13c of the annular path 13.

The first valve 116, the second valve 117, and the third valve 118 open or close a flow path in the refrigerant circuit 110. The control unit 9 can switch the refrigerant circuit 110 to any one of the first circulation path 21, the second circulation path 22, and the third circulation path 23 by operating the first valve 116, the second valve 117, and the third valve 118. The first circulation path 21 is configured by opening the first valve 116 and closing the second valve 117 and the third valve 118. The second circulation path 22 is configured by opening the second valve 117 and closing the first valve 116 and the third valve 118. The third circulation path 23 is configured by opening the third valve 118 and closing the first valve 116 and the second valve 117.

Although the embodiment and variations of the present invention are described above, the configurations described in the embodiment and variations, a combination of the configurations, and the like are merely examples, and thus, addition, omission, substation, and other alterations can be appropriately made within the scope not departing from the gist of the present invention. Further, the present invention is not limited by the embodiment.

For example, in the above-described embodiment and variations, the temperature control heat exchanger 4, the pump 5, and the inverter 3 are arranged in this order from the upstream side to the downstream side in a flow direction of a refrigerant in the first region 13a of the annular path 13. However, the arrangement of the temperature control heat exchanger 4, the pump 5, and the inverter 3 in the first region 13a is not limited to this order, and may be in any order.

Further, a refrigerant in the refrigerant circuit 10 may directly cool the motor 2 or may cool the motor 2 via separately prepared oil. In the case of directly cooling the motor 2, the refrigerant in the refrigerant circuit 10 passes through a housing of the motor 2 to cool the motor 2. In this case, the refrigerant may be water. Further, in the case where the refrigerant in the refrigerant circuit 10 cools the motor 2 via separately prepared oil, the motor 2 is provided with an oil pump, an oil cooler, and an oil path for circulating oil to cool the motor 2. The refrigerant in the refrigerant circuit 10 cools the oil in the oil cooler to indirectly cool the motor 2.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor unit mounted on a vehicle, the motor unit comprising:
a motor that drives the vehicle;
an inverter electrically connected to the motor;
a temperature control heat exchanger connected to a temperature control device of the vehicle; and
a refrigerant circuit that is a path through which a refrigerant circulates, wherein
the refrigerant circuit includes a first circulation path and a second circulation path switched to each other,
the first circulation path is a path passing through the inverter and the temperature control heat exchanger, and
the second circulation path is a path passing through the inverter, the temperature control heat exchanger, and the motor.

2. The motor unit according to claim 1, wherein
the refrigerant circuit includes a third circulation path to which switching can be made alternatively together with the first circulation path and the second circulation path, and
the third circulation path passes through the inverter, the temperature control heat exchanger, the motor, and a radiator.

3. The motor unit according to claim 2, wherein
the refrigerant circuit includes a control unit that alternatively switch the first circulation path, the second circulation path, and the third circulation path.

4. The motor unit according to claim 3, wherein
the control unit
sets the refrigerant circuit as the first circulation path in a case where a temperature of the motor is equal to or less than a first threshold, and
switches the refrigerant circuit to the second circulation path in a case where a temperature of the motor exceeds the first threshold.

5. The motor unit according to claim 4, wherein
the control unit
sets the refrigerant circuit as the third circulation path in a case where a temperature of the motor exceeds a second threshold larger than the first threshold or in a case where a temperature of the inverter exceeds a third threshold.

6. The motor unit according to claim 3, wherein
the control unit
switches the refrigerant circuit from the first circulation path to the second circulation path in a case where a temperature of the motor becomes higher than a temperature of the inverter.

7. The motor unit according to claim 3, wherein
the control unit sets the refrigerant circuit as the third circulation path in a case where a temperature of a refrigerant that passes through the temperature control heat exchanger exceeds a fourth threshold.

8. The motor unit according to claim 2, further comprising:
a pump that pressure-feeds the refrigerant in the refrigerant circuit, wherein
the pump is arranged on a path shared by the first circulation path, the second circulation path, and the third circulation path in the refrigerant circuit.

9. A temperature control system comprising: the motor unit according to claim 1; and the temperature control device, wherein
the temperature control device includes a temperature control refrigerant circuit that is a path through which a temperature control refrigerant circulates, and
the temperature control heat exchanger is arranged in a path of the temperature control refrigerant circuit, and performs heat exchange between the refrigerant and the temperature control refrigerant.

10. A vehicle comprising the motor unit according to claim 1.
